(19) United States
(12) Patent Application Publication
(10) Pub. No.: US 2025/0070417 A1
(43) Pub. Date: Feb. 27, 2025

(54) BATTERY CELL AND ASSOCIATED MANUFACTURING METHOD

(71) Applicant: SAFT, LEVALLOIS PERRET (FR)

(72) Inventors: Maxence BARDIAU, LE HAILLAN (FR); Valentin BLONZ, LE BOUSCAT (FR)

(73) Assignee: SAFT, LEVALLOIS PERRET (FR)

(21) Appl. No.: 18/721,994

(22) PCT Filed: Dec. 19, 2022
(86) PCT No.: PCT/EP2022/086723

§ 371 Date: Jun. 20, 2024

(30) Foreign Application Priority Data
Dec. 21, 2021 (FR) FR2114073

(51) Int. Cl. H01M 50/538; H01M 50/103; H01M 50/15; H01M 50/169; H01M 50/186; H01M 50/528; H01M 50/591

(52) U.S. Cl. CPC H01M 50/538; H01M 50/103; H01M 50/15; H01M 50/169; H01M 50/186; H01M 50/528; H01M 50/591

(57) ABSTRACT

The invention relates to a battery cell comprising a bucket, a lid attached to the bucket, at least one first electrochemical bundle in the bucket, at least one first polarity collector.

The first polarity collector is integral with the lid and defines at least one first welding surface located away from the bucket, to which the electrical connection tabs of the first electrodes of the first electrochemical bundle are welded.

The cover comprises an upper part delimiting at least a first through opening located opposite the first welding surface in a direction of elevation.

The battery cell further comprises a sealing device attached to the cover and designed to seal the first through opening.

### CROSS REFERENCE TO RELATED APPLICATIONS

The present application is a U.S. National Phase Application under 35 U.S.C. § 371 of International Patent Application No. PCT/EP2022/086723 filed Dec. 19, 2022, which claims priority of French Patent Application No. 21 14073 filed Dec. 21, 2021. The entire contents of which are hereby incorporated by reference.

### FIELD OF THE INVENTION

The present invention relates to a battery cell comprising:
a bucket delimiting an internal volume and an upper opening giving access to the internal volume extending substantially in a first plane,
a cover attached to the bucket and closing the internal volume,
at least one first electrochemical bundle received at least partly in the internal volume, the first electrochemical bundle comprising a plurality of stacks, each stack comprising a first polarity electrode, a second polarity electrode and a separator interposed between the first polarity electrode and the second polarity electrode, each of the first polarity and the second polarity electrodes comprising an electrical connection tab,
at least one first polarity collector.

### BACKGROUND

This invention is particularly applicable to electrochemical battery cells of prismatic format, especially lithium-ion cells.

Each first polarity electrode, for example, positive, and second polarity electrode, for example, negative, includes a metal support, for example, aluminum or copper, on which a layer including the active material is deposited. The layer including the active material of the negative electrode is placed facing that of the positive electrode, in order to optimize the electron exchange and the electrochemical performance of the cell.

To recover voltage and current, the electrochemical bundle is connected in its upper portion, via the electrical connection tabs of the first polarity and second polarity electrodes, to the terminals of the prismatic element by means of welding on metal connections.

When the bucket of the cell is closed, in order to maximize the space occupied by active material in the cell, and the electrical capacity of the cell, the cover that closes the cell is likely to exert a constraint on the tabs of the electrode.

As a result, these latter fold into the internal volume of the bucket, toward the stack, generally adopting a curved configuration. In this configuration, the tabs of the positive electrodes that are not coated with the layer including the active material are arranged close to the supports of the negative electrodes. In a similar manner, the tabs of the negative electrodes, which are not coated with the layer including the active material, are arranged close to the supports of the positive electrodes.

Normally, the separator arranged between each pair of facing positive and negative electrodes is interposed between each tab of a positive electrode and the facing negative electrode, and between each tab of a negative electrode and the facing positive electrode.

However, given the compression within the cell and the presence of the layer including the active material up to the upper edge of each electrode, there remains a substantial risk of short-circuiting in the event of poor insulation, particularly if the separator does not form a screen, and/or if the electrical connections are tightly packed. This reduces the reliability of the battery cell.

Furthermore, in this type of battery cell, the bending zone of the connection tabs occupies a large space in the internal volume of the bucket, limiting the dimensions of the electrodes inside the bucket and consequently the capacity of the battery cell.

### SUMMARY

One aim of the invention is therefore to provide a battery cell that is simple to manufacture and minimizes the risk of short-circuits during manufacture, while at the same time allowing the electrical capacity of the cell to be optimized.

To this end, the invention has as its object a battery cell, such as defined above, in which the first polarity collector is integral with the lid and defines at least a first welding surface located away from the internal volume of the bucket, the electrical connection tabs of the first polarity electrodes being welded to said first welding surface,
the cover comprising an upper part delimiting at least a first through opening located facing the first welding surface according to a direction of elevation,
the battery cell further comprises a sealing device attached to the cover and intended to close the first through opening in a sealed manner.

Thus, the manufacture of the battery cell is facilitated, since the number of components making up the battery cell is reduced. Moving the weld between the first polarity collector and the electrical connection tabs to the outside of the bucket allows the dimensions of the electrode supports present in the internal volume of the bucket to be increased, and consequently to increase the capacity of the battery cell. In addition, the manufacture of the battery cell is simplified and more reliable, since the welding of the electrical connection tabs to the collector is carried out after the cover has been fitted to the bucket, through the first through-opening. The risk of short circuits is also reduced, as the bending radius of the electrical connection tabs is increased.

The battery cell according to the invention may comprise one or more of the following features, taken alone or in any technically possible combination:
the cover defines an interior space in communication with the internal volume of the bucket, the first welding surface being located in the interior space of the cover;
the first welding surface extends in a plane substantially parallel to the first plane;
the first welding surface extends in a plane forming an angle with the first plane of between 30° and 60°, advantageously substantially equal to 45°.
the first polarity collector comprises a connection portion and a connection terminal connected to the connection portion, the connection portion defining the first welding surface, the connection terminal defining at least one free surface oriented toward the exterior of the internal volume;
the upper part of the cover is overmolded onto the first polarity collector;
the sealing device comprises at least one first sealing flap mounted on the upper part of the cover, and displaceable relative to the upper part of the cover between an open position in which the first sealing flap is arranged away from the first through opening, and a closed position in which the first sealing flap closes the first through opening in a sealed manner;
the cover comprises a base structure integral with the upper part of the cover, the sealing device comprises an upper lid attached in a sealed manner to the base structure and closing at least the first through opening;
the upper lid defines at least two through openings in communication with the internal volume of the bucket;
the sealing device comprises at least a first layer of insulating material attached to a lower face of the upper lid and arranged facing the first welding surface according to the direction of elevation;
the cover comprises at least a first insulating tab movable relative to the upper part of the cover between an open position in which the first insulating tab is away from the first through opening, and a closed position in which the first insulating tab is located facing the first through opening according to the direction of elevation;
the cover comprises a stop member resting on the first electrochemical bundle; and
the battery cell comprises a second polarity collector, the first polarity collector being integral with the cover and defining at least a first welding surface located away from the internal volume of the bucket, the electrical connection tabs of the second polarity electrodes being welded to said first welding surface.

The invention also relates to a method for manufacturing a battery cell such as described above, the method comprising:
arranging the electrochemical bundle inside the internal volume of the bucket,
attaching the first polarity collector to the upper part of the cover,
welding the upper part of the cover to the bucket,
welding the electrical connection tabs of the first polarity electrodes to the first welding surface of the first polarity collector, and
attaching the sealing device on the cover to close the first through opening in a sealed manner.

### BRIEF DESCRIPTION OF THE DRAWINGS

The invention will be better understood on reading the following description, given by way of example only, and made with reference to the appended drawings, in which:

FIGS. 1 and 2 are perspective views of a battery cell according to a first embodiment of the invention,

FIG. 3 is a section according to a longitudinal direction of the upper part of the battery cell shown in FIG. 2,

FIG. 4 is a perspective view of a collector of the battery cell in FIGS. 1 and 2,

FIG. 5 is a cross-section according to the transverse direction of the upper part of the battery cell in FIGS. 1 and 2,

FIG. 6 is a perspective view of a battery cell according to a second embodiment of the invention,

FIG. 7 is a perspective view of the upper part of the battery cell of FIG. 6 without the upper lid,

FIG. 8 is a cross-section according to a transverse direction of the upper part of the battery cell shown in FIG. 6,

FIGS. 9 to 11 are perspective views of various parts of the battery cell cover FIG. 6, and

FIGS. 12 and 13 are perspective views of the cover of a battery cell according to a third embodiment of the invention.

### DETAILED DESCRIPTION

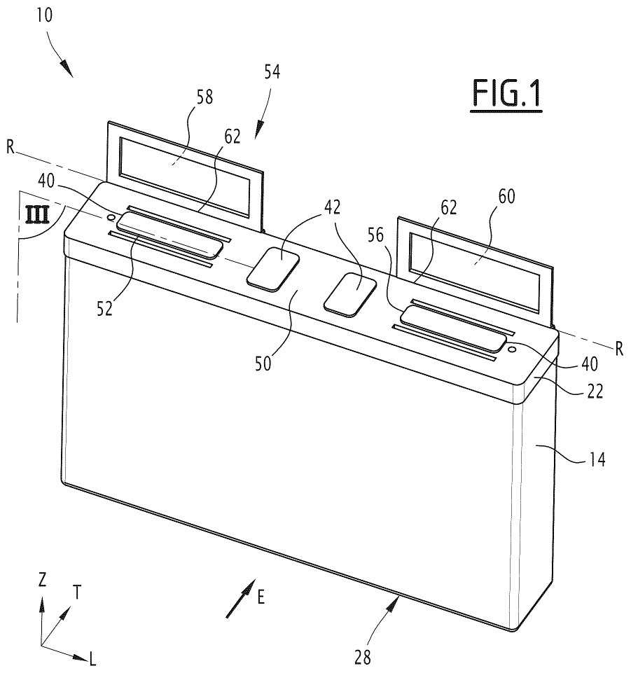

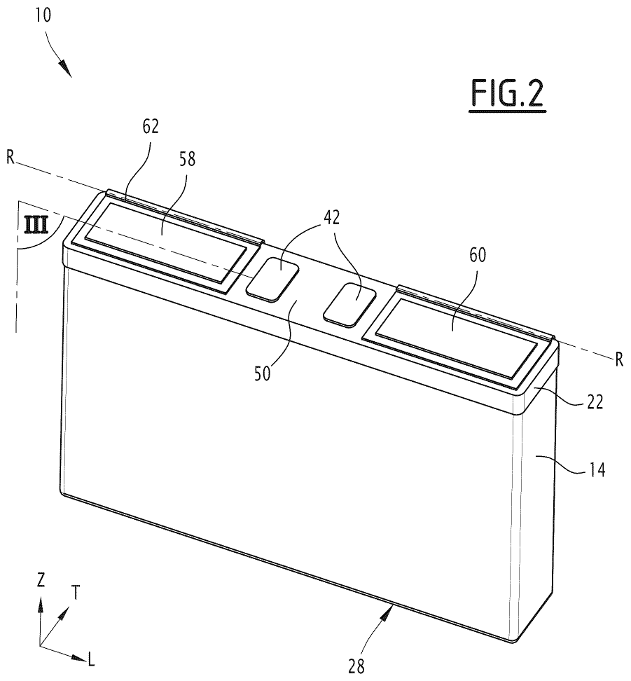

FIGS. 1 and 2 illustrate a prismatic cell 10 of a battery according to a first embodiment.

In the remainder of the description, orientations are defined with reference to the battery cell 10 placed on a horizontal surface. The longitudinal direction L corresponds to the main elongation direction of the battery cell 10. The transverse direction T is substantially perpendicular to the longitudinal direction L and corresponds substantially to the stacking direction E of the electrode stacks. The direction of elevation Z is substantially perpendicular to the longitudinal direction L and to the transverse direction T. It is substantially coincident with the vertical direction when the battery cell 10 is placed on a horizontal surface. The terms “upper” and “lower” are used with reference to the direction of elevation Z.

The battery is an electrochemical battery such as typically used in rail vehicles or aircraft. However, other fields of application for the battery are conceivable, such as motor vehicles, energy storage or electric mobility.

The battery cell 10 comprises a housing or bucket 14 defining an internal volume 16 and at least one first electrochemical bundle 18 arranged in the internal volume 16 of the bucket 14.

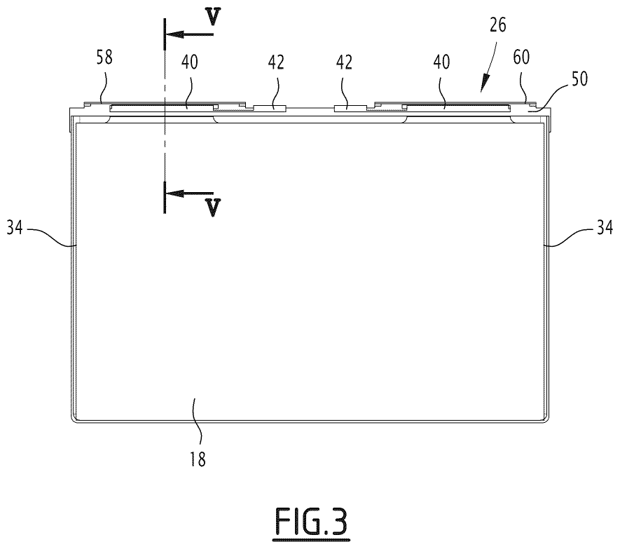

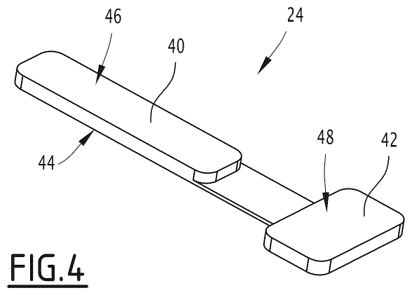

In the example shown in FIGS. 1 to 5, the battery cell 10 further comprises a second electrochemical cell 20 arranged inside the internal volume 16, facing the first electrochemical cell 18 according to the transverse direction T.

The battery cell 10 further comprises a cover 22 attached to the bucket 14 and closing the internal volume 16 and at least one first polarity collector 24.

The cover 22 defines an interior space 25 in communication with the internal volume 16 of the bucket 14.

In the illustrated example, the battery cell 10 further comprises a second polarity collector 26.

As seen in FIGS. 1 and 2, the bucket 14 includes a bottom wall 28 and a side wall 30 projecting from the bottom wall 28 to delimit the internal volume 16. In the example shown, the bucket 14 is parallelepiped, in particular rectangular parallelepiped. The internal volume 16 of the bucket 14 opens out through an upper opening 32 giving access to the internal volume 16, which opens upward when the bottom wall 28 is placed on a horizontal support. The upper opening 32 extends substantially in a first plane P1.

The bucket 14 is, for example, made of plastic, in particular a plastic that withstands the resulting chemical attack of the electrolyte contained in the bucket 14, for example, polypropylene (PP), polyphenylene sulfide (PPS), polyethylene terephthalate (PET), polybutylene terephthalate (PBT) or polyethylene (PE). Alternatively, the bucket 14 is made of aluminum.

Each electrochemical bundle 18, 20 is received in the internal volume 16. Preferably, the volume occupied by the electrochemical bundle(s) 18, 20 is greater than 70% of the internal volume 16. In the battery cell according to the invention, this volume is between 8% and 12% greater than the volume occupied by the electrochemical bundle(s) of a battery cell of the state of the art presenting a bucket of the same dimensions.

Each electrochemical bundle 18, 20 includes at least one stack, preferably a plurality of successive stacks stacked according to the stacking direction E. Each stack includes a first polarity electrode (not shown), for example, a positive electrode, a second polarity electrode (not shown), for example, a negative electrode, and a separator (not shown) interposed between the electrodes.

Each electrochemical bundle 18, 20 is further received in an electrolyte, present in the internal volume 16 to saturate the electrodes and the separator.

The first polarity electrode includes a flat support, a layer including the active material covering the support and an electrical connection tab 34 projecting upward according to the direction of elevation Z relative to the support to allow electrical connection of the electrochemical bundle 18, 20.

The support is preferably metal. It constitutes a current collector. It is made, for example, of strip, particularly thin strip with a thickness of less than 20 μm. The support is made of aluminum, for example.

The support presents, for example, a substantially polygonal contour, in particular a rectangular contour. It extends according to the direction of elevation Z between a lower edge and an upper edge. It extends according to the longitudinal direction L between a first lateral edge located in the vicinity of the electrical connection tab 34, and a second lateral edge, located opposite the electrical connection tab 34.

The layer including the active material covers the whole of at least one face of the support, vertically between the lower edge and the upper edge, and horizontally between the first lateral edge and the second lateral edge. It does not cover the tab 34, which remains bare.

The separator is made of a sheet, preferably an electrically insulating sheet. It is made, for example, of a sheet of polymeric material, in particular polyolefin, which is preferably permeable to lithium ions.

The thickness of the separator is, for example, less than 25 μm. Advantageously, the edges of the separator project beyond the edges of the electrode supports.

The electrolyte is liquid, for example. Alternatively, the electrolyte may be in solid or gel form.

According to the invention, each of the first-polarity collectors 24 and the second-polarity collectors 26 is integral with the cover 22.

Each collector 24, 26 respectively defines at least one first welding surface 36 of the electrical connection tabs 34 of the electrodes of the same polarity of the first electrochemical bundle 18. In the illustrated example, each collector 24, 26 further defines a second welding surface 38 of the electrical connection tabs of the electrodes of the same polarity as the second electrochemical bundle 20.

The welding surface(s) 36, 38 of each of the collectors 24, 26 are located away from the internal volume 16 of the bucket 14. More specifically, the welding surface(s) 36, 38 are located inside the interior space 25 of the cover 22.

Each collector 24, 26 extends principally according to the longitudinal direction L. The collector 24, 26 comprises a connection portion 40 of the tabs 34 and a connection terminal 42 connected to the connection portion 40. Preferably, the connection portion 40 and the connection terminal 42 are integral with each other. In other words, connection portion 40 and connection terminal 42 are made in one piece from the same material.

The connection portion 40 defines the welding surface(s) 36, 38. In the first embodiment illustrated in FIGS. 1 to 5, the connection portion 40 has the shape of a parallelepiped bar extending principally according to the longitudinal direction L. The connection portion 40 extends between a lower face 44 and an upper face 46 according to the elevation direction of elevation Z.

The upper face 46 is oriented away from the internal volume 16. It defines each welding surface 36, 38 of the electrical connection tabs 34. The upper face 46, and thus the welding surface(s) 36, 38, extend(s) for example in a second plane P2 substantially parallel to the first plane P1 in which the upper opening 32 of the bucket 14 extends. The upper face 46 is located opposite the lower face 44. It is substantially parallel to the lower face 44.

The lower face 44 extends substantially in a plane P3. It is oriented toward the internal volume 16 of the bucket 14. It is separated, for example, from the upper edge of the electrode support by a distance taken according to the direction of elevation Z of between 1 mm and 4 mm.

Each of the collectors 24, 26 is metallic and electrically conductive. It is made, for example, of aluminum, copper or a copper/aluminum bimaterial.

Each electrical connection tab 34 projects upward from the upper edge of the electrode support. In this example, each tab 34 is integrally formed with the support being made of the same material. It is connected at its base along its sides to the upper edge of the support.

The electrical connection tabs 34 of the first polarity electrodes of the first electrochemical bundle 18 are welded to the first welding surface 36 of the first polarity collector 24. The electrical connection tabs 34 of the first polarity electrodes of the second electrochemical bundle 20 are welded to the second welding surface 38 of the first polarity collector 24.

In a similar manner, the electrical connection tabs 34 of the second polarity electrodes of the first electrochemical bundle 18 are welded to the first welding surface 36 of the second polarity collector 26, and the electrical connection tabs 34 of the second polarity electrodes of the second electrochemical bundle 20 are welded to the second welding surface 38 of the second polarity collector 26.

Preferably, the tabs 34 of the electrodes of the same polarity of each stack of the same bundle 18, 20 are joined to each other, and are folded before being welded to the welding surface 36, 38.

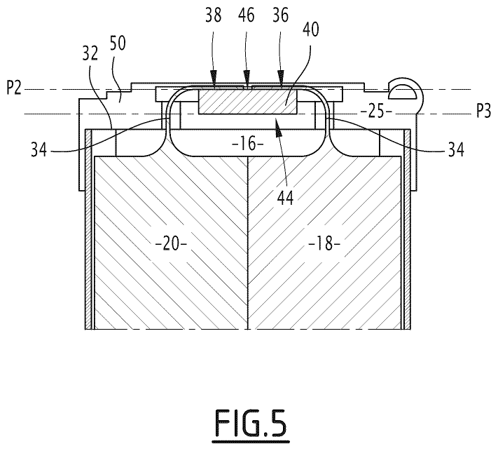

As can be seen, in particular, in FIG. 5, in a transverse plane substantially perpendicular to the supports, the bend of the electrical connection tabs 34 presents a curved shape.

The electrical connection tabs 34 of the first polarity electrodes of the first electrochemical bundle 18 are bent toward the connection portion 40 of the first polarity collector 24, and more particularly, toward the first welding surface 36. In a similar manner, the electrical connection tabs 34 of the first polarity electrodes of the second electrochemical bundle 20 are bent toward the connection portion 40 of the first polarity collector 24, and more particularly, toward the second welding surface 38. The tabs 34 of the first electrochemical bundle 18 and the tabs 34 of the second electrochemical bundle 20 are located facing each other according to the transverse direction T.

The connection terminal 42 defines at least one free surface 48 oriented away from the internal volume 16 of the bucket 14. The connection terminal 42 allows the electrical power from the battery cell 10 to be recovered and allows the battery cells 10 to be connected to each other. The free surface 48 is flat, for example, as shown in FIGS. 1 and 2, to allow the battery cells to be connected by welding. Alternatively (not shown), the connection terminal 42 defines a threaded recess or comprises an insert intended for connecting the battery cells 10 by screwing.

The connection terminal 42 extends, for example, from an upper surface of the cover 22 opposite the internal volume 16 of the bucket 14.

Preferably, the cover 22 is welded to the bucket 14 to close the internal volume 16.

According to the invention, the cover 22 comprises an upper part 50 delimiting at least one first through opening 52.

The first opening 52 is located facing the first welding surface 36 according to the direction of elevation Z.

In the illustrated example, the upper part 50 of the cover 22 further defines a second through opening 56 located facing the second welding surface 38 of the second polarity collector 26 according to the elevation direction Z.

Each through opening 52, 56 allows access to the corresponding welding surface 36, 38, thus facilitating welding of the electrical connection tabs 34 to the welding surface 36, 38.

The upper part 50 of the cover 22 is preferably made of plastic, for example polypropylene (PP), polyphenylene sulfide (PPS), polyethylene terephthalate (PET), polybutylene terephthalate (PBT) or polyethylene (PE).

Advantageously, each of the collectors 24, 26 is integral with the upper part 50 of the cover 22. Preferably, the upper part 50 of the cover 22 is overmolded onto the collectors 24, 26. By “overmolded”, we mean that the upper part 50 made of a thermoplastic or thermosetting resin is injected in contact with the collectors 24, 26 previously positioned in the injection tool.

According to the invention, the battery cell 10 comprises a sealing device 54 intended to be attached to the upper part 50 of the cover 22 in a sealed manner and to close at least the first opening 52.

In the first embodiment, the sealing device 54 comprises a first sealing flap 58 and a second sealing flap 60 intended to be attached to the upper part 50 of the cover 22 and to seal the first through opening 52 and the second through opening 56 respectively.

Each sealing flap 58, 60 is displaceable relative to the upper part 50 of the cover 22 between an open position (FIG. 1), in which the sealing flap 58, 60 is arranged away from the through opening 52, 56, and a closed position (FIG. 2), in which the sealing flap 58, 60 closes the through opening 52, 56 in a sealed manner.

Each sealing flap 58, 60 is connected, for example, to the upper part 50 of the cover 22 by an outer edge 62. Each sealing flap 58, 60 is movable in rotation, between the open position and the closed position, relative to the upper part 50 of the cover 22 about an axis of rotation R substantially parallel to the longitudinal direction L, passing through the outer edge 62.

Each sealing flap 58, 60 is for example plastic, for example polypropylene. Preferably, in the closed position, the sealing flap 58, 60 is thermally welded to the upper part 50 of the cover 22.

A method of manufacturing a battery cell 10 according to the first embodiment will now be described.

Initially, the electrode supports are manufactured by unrolling a strip of metal foil. The strip is coated with an ink notably including the active material to form each electrode. Advantageously, the ink also contains a binder and an electrically conductive compound. The deposit forms the layer containing the active material. The strip is then embossed to obtain the contour of each of the supports and respective tabs 34.

The tabs 34 are not coated with ink comprising the active material.

Stacks are then formed, with a negative electrode facing a positive electrode, with the interposition of a separator. The stacks are juxtaposed according to the stacking direction E to form one or more electrochemical bundles 18, 20.

The electrochemical bundle(s) 18, 20 are then arranged inside the internal volume 16 of the bucket 14.

Within each electrochemical bundle 18, 20, the tabs 34 of the first polarity electrodes of each stack are joined to each other by their free ends. In the same manner, the tabs 34 of the second polarity electrodes in each stack are joined together at their free ends.

The collector(s) 24, 26 are made integral with the cover 22 and more particularly with the upper part 50 of the cover 22. Preferably, the upper part 50 of the cover 22 is overmolded onto the collectors 24, 26.

The cover 22 is then arranged on the bucket 14 and welded to the bucket 14, for example by laser welding.

The electrical connection tabs 34 of the first polarity electrodes of the electrochemical bundle(s) 18, 20 are then welded to the welding surfaces 36, 38 of the first polarity collector 24, for example by laser welding. In a similar manner, the electrical connection tabs 34 of the second polarity electrodes of the electrochemical bundle(s) 18, 20 are welded to the welding surfaces 36, 38 of the second polarity collector 26.

Welding takes place through the first and second through openings 52, 56 in the upper part 50 of the cover 22.

Finally, the sealing device 54 is attached to the upper part 50 of the cover 22 to close the through openings 52, 56 in a sealed manner.

More particularly, in the first embodiment, each sealing flap 58, 60 is moved from the open position toward the closed position and then thermally welded to the upper part 50 of the cover 22 so as to close the through openings 52, 56 in a sealed manner.

Preferably, before the sealing flaps 58, 60 are closed, the internal volume 16 of the bucket 14 is filled with electrolyte through the first opening 52 and/or the second opening 56.

Thus, the battery cell 10 , according to the invention, is particularly advantageous. Indeed, the manufacture of the battery cell 10 is facilitated since the number of components making up the battery cell 10 is reduced. In particular, the tabs 34 of the first polarity electrodes are welded directly to the first polarity collector 24 without the need for an intermediate connector. By removing the weld between the collector 24 and the electrical connection tabs 34 to the outside of the bucket 14, it allows the dimensions of the electrode supports present in the internal volume 16 of the bucket 14 to be increased, thereby increasing the capacity of the battery cell 10. The manufacture of the battery cell 10 is facilitated since the welding of the electrical connection tabs 34 to the collector 24 takes place after the cover 22 has been fitted to the bucket 14. The risk of short circuits is also reduced, as the bending radius of the electrical connection tabs 34 is increased.

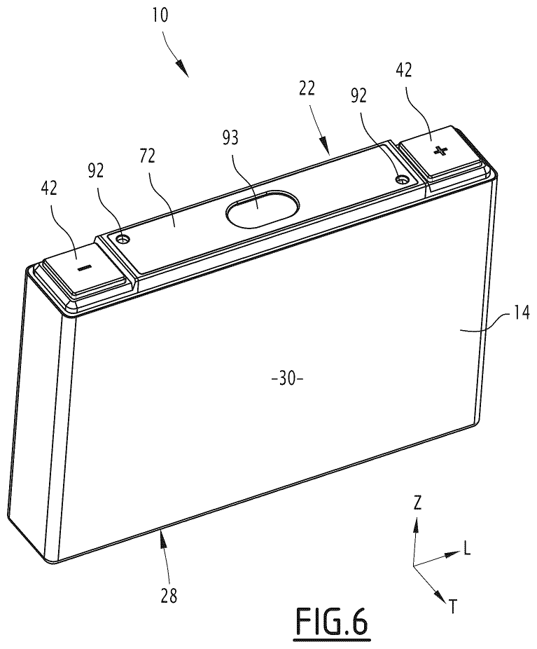

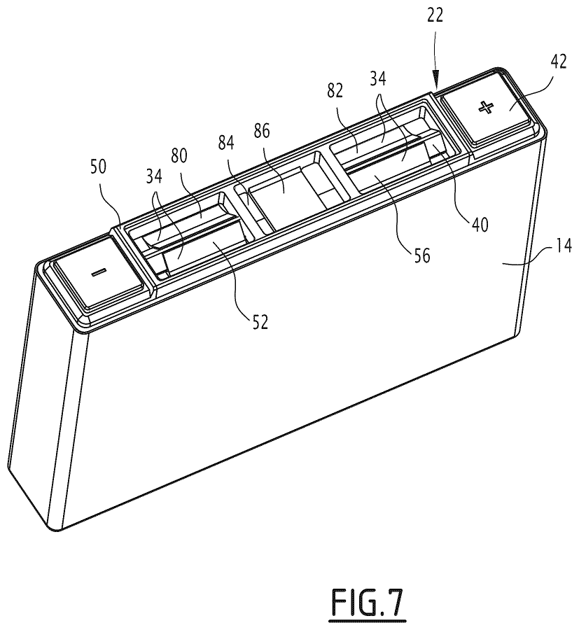

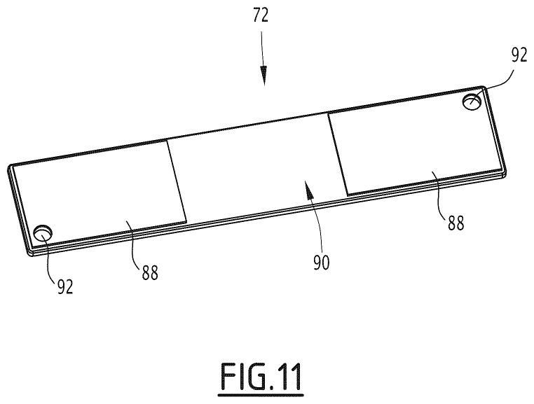

A second embodiment of the invention is described with reference to FIGS. 6 to 11. This embodiment will be described in terms of differences relative to the first embodiment.

In the second embodiment, the bucket 14 is of metal, preferably aluminum.

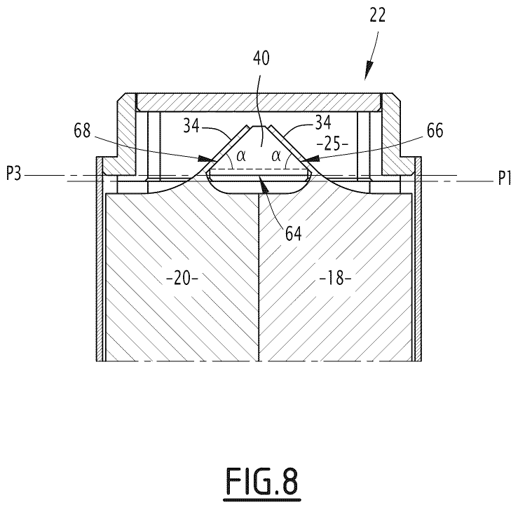

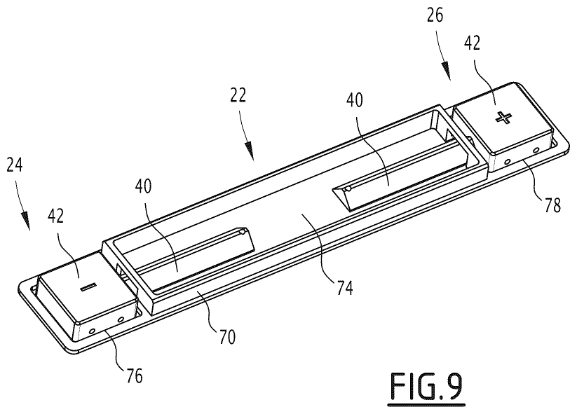

As seen in particular in FIGS. 8 and 9, the connection portion 40 of each of the collectors of the first polarity and second polarity 24, 26 defines a lower face 64, oriented toward the internal volume 16 of the bucket 14, substantially parallel to the first plane P1, a first lateral face 66 and a second lateral face 68 connected to the lower face 64. The lateral faces 66, 68 are arranged on either side of the lower face 64 according to the transverse direction T. Preferably, each of the lateral faces 66, 68 forms an angle a with the lower face 64 of between 30° and 60°, advantageously substantially equal to 45°. This allows bending of the electrical connection tabs 34, to be limited, avoiding mechanical breakage of the electrical connection tabs 34 during the welding step on the collector 24, 26 and limiting the risk of short-circuits.

The first lateral face 66 defines the first welding surface 36. The second side face 68 defines the second welding surface 38.

It is understood that the first embodiment may, alternatively, comprise a collector 24, 26 with a connection portion 40 presenting, these same characteristics.

FIGS. 9, 10, 11 illustrate the various elements of the cover 22 of the battery cell 10 of the second embodiment.

The cover 22 comprises, in addition to the upper part 50, a base structure 70 to which the upper part 50 is attached.

The base structure 70 is preferably metal, for example aluminum. It defines a central housing 74, a first lateral housing 76 and a second lateral housing 78 arranged on either side of the central housing 74 according to the longitudinal direction L.

The first lateral housing 76 and the second lateral housing 78 respectively receive at least in part the connection terminal 42 of the first polarity collector 24 and the connection terminal 42 of the second polarity collector 26. The central housing 74 receives the connection portions 40 of the first and second polarity collectors 24, 26.

The upper part 50 of the lid 22 is integral with the first and second polarity collectors 24, 26 and the base structure 70.

Preferably, the upper part 50 of the cover 22 is overmolded onto the collectors 24, 26 and the base structure 70. By “overmolded”, we mean that the upper part 50 made of a thermoplastic or thermosetting resin is injected into contact with the collectors 24, 26 and the base structure 70 previously positioned in the injection tool.

The upper part 50 of the cover 22 delimits within the central housing 74 a first housing 80, a second housing 82 and a third housing 84 between the first housing 80 and the second housing 82. Each of the housings 80, 82, 84 is in communication with the internal volume 16 of the bucket 14.

The first housing 80 opens upward through the first through opening 52. The second housing 82 opens upward through the second through opening 56.

The connection portion 40 of the first polarity collector 24 is located in the first housing 80. The connection portion 40 of the second polarity collector 26 is located in the second housing 82.

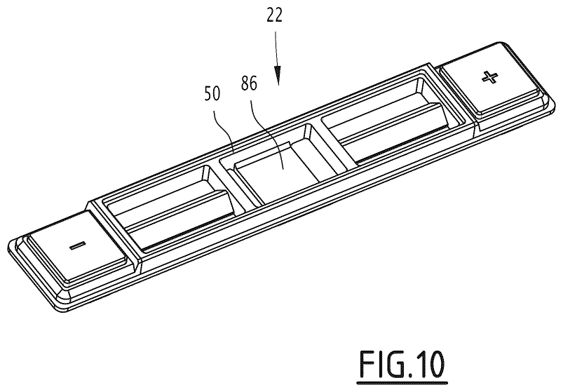

Advantageously, the cover 22 also comprises a stop member 86 resting on the electrochemical bundle(s) 18, 20. For example, as seen in FIG. 10, the stop member 86 is formed by a plate projecting from a lower face of the upper part 50 of the cover 22 toward the internal volume 16 of the bucket 14. The stop member 86 is arranged, for example, facing the third housing 84 according to the direction of elevation Z. Preferably, the stop member 86 defines a lower face extending in a plane substantially parallel to the first plane P1, resting on the electrochemical bundle(s) 18, 20. This allows to prevent part of the stacks from being ejected in the event of overpressure inside the bucket 14.

In the second embodiment, the sealing device 54 comprises an upper lid 72 attached to the cover 22, and more particularly to the base structure 70. The upper lid 72 is attached, for example, by welding. It closes each of the first, second and third housings 80, 82, 84 and thus closes the first through opening 52 and the second through opening 56 in a sealed manner.

Alternatively, the upper lid 72 is attached to the upper part 50 of the cover 22.

The upper lid 72 is preferably of metal, for example aluminum.

Preferably, the sealing device 54, in addition, comprises at least one layer of electrical insulating material 88 attached to a lower face 90 of the upper lid 72 oriented toward the internal volume 16 of the bucket 14. In particular, in the illustrated example, the sealing device 54 comprises a first layer of electrical insulating material 88 attached to the lower face 90 of the upper lid 72 facing the first through opening 52 according to the direction of elevation Z, and a second layer of electrical insulating material 88 attached to the lower face 90 of the upper lid 72 facing the second through opening 56 in the direction of elevation Z.

The electrical insulating material is advantageously polyphenylene sulfide (PPS). Alternatively, it can be made of polypropylene (PP), polyethylene terephthalate (PET), polybutylene terephthalate (PBT) or polyethylene (PE).

The insulating material allows the connection portions 40 of the collectors 24, 26 to be insulated from the upper lid 72, and thus avoid any short-circuit between the two collectors 24, 26.

Advantageously still, the upper lid 72 defines at least two through openings (ports) 92 in communication with the internal volume 16 of the bucket 14.

These ports 92 facilitate filling of the bucket 14 and saturation of the stacks. For example, they enable filling to be carried out at two distinct points on the battery cell 10, or filling to be carried out through one port 92 and vacuuming through the other port 92.

Advantageously still, the upper lid 72 comprises a valve 93 intended to evacuate excess fluid pressure from the internal volume 16 of the bucket 14.

A method for manufacturing a battery cell 10 according to the second embodiment is now described. Only the differences with the manufacturing method of the first embodiment will be described here.

Once the electrical connection tabs 34 have been welded to the collectors 24, 26, the upper lid 72 is positioned on the base structure 70 of the cover 22 and welded to close the first through opening 52 and the second through opening 56 in a sealed manner. In particular, the upper lid 72 also closes the third housing 84 in a sealed manner.

Preferably, the bucket 14 is filled with electrolyte using the two ports 92 in the upper lid 72, which are then plugged.

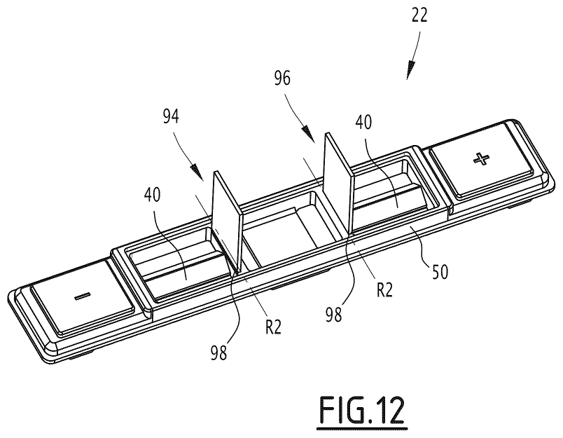

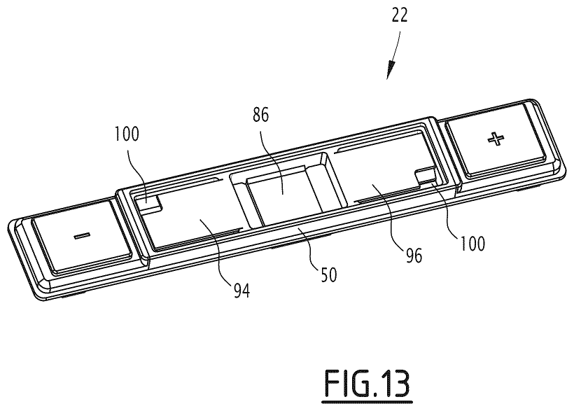

A third embodiment of a battery cell 10 according to the invention is illustrated in FIGS. 12 and 13. This embodiment is described in terms of differences from the second embodiment.

In this embodiment, the sealing device 54 does not comprise layers of electrical insulating material 88.

The cover comprises a first insulating tab 94 and a second insulating tab 96. The first insulating tab 94 is displaceable relative to the upper part 50 of the cover 22 between a first open position (FIG. 12) in which the first insulating tab 94 is located away from the first opening 52, and a closed position (FIG. 13) in which the first insulating tab 94 extends facing the first opening 52 according to the direction of elevation Z. in a similar manner, the second insulating tab 96 is displaceable relative to the upper part 50 of the lid 22 between a first open position (FIG. 12) in which the second insulating tab 96 is located away from the second opening 56, and a closed position (FIG. 13) in which the second insulating tab 96 extends facing the second opening 56 in the direction of elevation Z. The insulating tabs 94, 96 have the same function as the layers of electrical insulating material 88. They allow, in the closed position, to electrically insulate the connection portions 40 of the upper lid 72.

Preferably, each insulating tab 94, 96 is movable in rotation relative to the upper part 50 of the cover 22 between the open position and the closed position relative to an axis of rotation R2 substantially parallel to the transverse direction T. For example, the insulating tongue 94, 96 is connected to the upper part 50 of the cover 22 by a hinge.

Alternatively, the insulating tab 94, 96 is integral with the upper part 50 of the cover 22. It is connected to the upper part 50 of the cover 22 by a connecting portion 98 able to allow bending of the insulating tab 94, 96 from the open position toward the closed position. For example, the connection portion 98 presents, a thickness according to the elevation direction Z which is thinner relative to the thickness of the insulating tab 94, 96 and the region of the upper part 50 of the cover 22 to which it is connected.

Preferably, each insulating tab 94, 96 defines a passage 100, here a notch, arranged facing the port 92 of the upper lid 72 to allow filling of the internal volume 16 of the bucket 14.

During manufacture of the battery cell 10, before securing the upper lid 72, the insulating tabs 94, 96 are displaced from the open position to the closed position to ensure electrical insulation between the upper lid 72 and the connection portions 40 of the collectors 24, 26.

Alternatively, for the second and third embodiments, the battery cell 10 further comprises a first seal (not shown) arranged between the connection terminal 42 of the first polarity collector 24 and the base structure 70, and a second seal (not shown) interposed between the connection terminal 42 of the second polarity collector 26 and the base structure 70. The first and second seals are made of elastomer, for example.

The first and second seals are thus compressed in the mold used to overmold the cover 22. In particular, the upper part 50 of the overmolded cover 22 traps the first seal and the second seal against the aluminum parts, that is, the connection terminals 42 and the base structure 70, to ensure a good seal of the cover 22.

1. A battery cell comprising:
a bucket delimiting an internal volume and an upper opening giving access to the internal volume extending substantially in a first plane,
a cover attached to the bucket and closing the internal volume,
at least one first electrochemical bundle received at least partly in the internal volume, the first electrochemical bundle comprising a plurality of stacks, each stack comprising a first polarity electrode, a second polarity electrode and a separator interposed between the first polarity electrode and the second polarity electrode, each of the first polarity and second polarity electrodes comprising an electrical connection tab,
at least one first polarity collector,
wherein the first polarity collector is integral with the cover and defines at least a first welding surface located away from the internal volume of the bucket, the electrical connection tabs of the first polarity electrodes being welded to said first welding surface,
the cover comprising an upper part delimiting at least a first through opening located facing the first welding surface in a direction of elevation, and
the battery cell further comprising a sealing device attached to the cover and designed to close the first through opening in a sealed manner.

2. The battery cell according to claim, wherein the cover defines an interior space in communication with the internal volume of the bucket, the first welding surface being located in the interior space of the cover.

3. The battery cell according to claim 1, wherein the first welding surface extends in a plane substantially parallel to the first plane.

4. The battery cell according to claim 1, wherein the first welding surface extends in a plane forming an angle with the first plane of between 30° and 60°.

5. The battery cell according to claim 1, wherein the first polarity collector comprises a connection portion and a connection terminal connected to the connection portion, the connection portion defining the first welding surface, the connection terminal defining at least one free surface facing outward from the internal volume.

6. The battery cell according to claim 1, wherein the upper portion of the cover is overmolded onto the first polarity collector.

7. The battery cell according to claim 1, wherein the sealing device comprises at least one first sealing flap mounted on the upper part of the cover, and displaceable relative to the upper part of the cover between an open position wherein the first sealing flap is arranged away from the first through opening, and a closed position wherein the first sealing flap closes the first through opening in a sealed manner.

8. The battery cell according to claim 1, wherein the cover comprises a base structure integral with the upper part of the cover, the sealing device comprises an upper lid attached in a sealed manner to the base structure and closing at least the first through opening.

9. The battery cell according to claim 8, wherein the upper lid defines at least two through openings in communication with the internal volume of the bucket.

10. The battery cell according to claim 8, wherein the sealing device comprises at least one first layer of insulating material attached to a lower face of the upper lid and arranged facing the first welding surface according to the direction of elevation.

11. The battery cell according to claim 8, wherein the cover comprises at least one first insulating tab displaceable relative to the upper portion of the cover between an open position wherein the first insulating tab is away from the first through opening, and a closed position wherein the first insulating tab is located facing the first through opening in the direction of elevation.

12. The battery cell according to claim 1, wherein the cover comprises a stop member resting on the first electrochemical bundle.

13. The battery cell according to claim 1, wherein the battery cell comprises a second polarity collector, the first polarity collector being integral with the cover and defining at least a first welding surface located away from the internal volume of the bucket, the electrical connection tabs of the second polarity electrodes being welded to said first welding surface.

14. A method for manufacturing a battery cell according to claim 1, the method comprising:
arranging the first electrochemical bundle inside the internal volume of the bucket,
attaching the first polarity collector to the upper part of the cover,
welding the upper part of the cover to the bucket,
welding the electrical connection tabs of the first polarity electrodes to the first welding surface of the first polarity collector, and
attaching the sealing device to the cover to close the first through-opening in a sealed manner.

15. The battery cell according to claim 4, wherein the first welding surface extends in a plane forming an angle with the first plane substantially equal to 45°.
